(19) United States
(12) Patent Application Publication
(10) Pub. No.: US 2006/0230455 A1
(43) Pub. Date: Oct. 12, 2006

(54) Apparatus and methods for file system with write buffer to protect against malware

(76) Inventors: Yuan-Chang Lo, Austin, TX (US); Gary d. Huber, Austin, TX (US)

Correspondence Address: O'KEEFE, EGAN & PETERMAN, 1101 CAPITAL OF TEXAS HIGHWAY SOUTH, #C200, AUSTIN, TX, 78746, US

(21) Appl. No.: 11/103,771

(22) Filed: Apr. 12, 2005

(51) Int. Cl. G06F 12/14

(52) U.S. Cl. 726/24

(57) ABSTRACT

The inventive concepts relate to avoiding or preventing infection of an information handling system with malware. In one embodiment, an information handling system includes a write filter and a storage device. The storage device couples to the write filter. The write filter is configured to selectively provide information to the storage device, depending, at least in part, on whether malware is detected in the information.

### TECHNICAL FIELD

The inventive concepts relate generally to information handling apparatus and systems. More particularly, the invention concerns apparatus and associated methods for providing a file system with a write buffer that protects against malware, such as computer viruses, worms, Trojan horses, adware, spyware, and the like.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

As information handling systems have become more ubiquitous, security of such systems has become more vital. One aspect of the security of the systems relates to data security against attacks of unauthorized or hostile parties that use malware to attack the systems. With the proliferation of malware over time, users and system administrators have allocated significant resources to protecting information handling systems against the attacks. Thus, malware, even if it does not destroy data or otherwise harm the system, still reduces productivity of the users and system administrators. A need therefore exists for a way of protecting against malware with relatively little impact on the user's productivity and on the use of system resources.

### SUMMARY

The disclosed novel concepts relate to apparatus and methods for providing file systems or storage subsystems with write filters and associated methods. More specifically, the inventive concepts relate to avoiding or preventing infection of an information handling system with malware. In one exemplary embodiment, an information handling system includes a write filter and a storage device. The storage device couples to the write filter. The write filter is configured to selectively provide information to the storage device, depending, at least in part, on whether malware is detected in the information.

In another exemplary embodiment, an apparatus includes a controller. The controller has a write filter and a temporary storage device. The temporary storage device couples to the write filter. The write filter causes the storing of information in the temporary storage device to determine presence of malware in the information.

In yet another embodiment, a method of preventing infection of a computer system with malware includes temporarily storing information in the computer system, and scanning the information to determine presence of malware. The method further includes using a write filter to cause saving of the information in the computer system, depending on whether scanning the information detects presence of malware in the information.

### BRIEF DESCRIPTION OF THE DRAWINGS

The appended drawings illustrate only exemplary embodiments of the invention and therefore should not be considered or construed as limiting its scope. Persons of ordinary skill in the art who have the benefit of the description of the invention appreciate that the disclosed inventive concepts lend themselves to other equally effective embodiments. In the drawings, the same numeral designators used in more than one drawing denote the same, similar, or equivalent functionality, components, or blocks.

FIG. 1 shows an information handling system that includes a storage subsystem according to an exemplary embodiment of the invention.

FIG. 2 illustrates a block diagram of a storage subsystem according to an exemplary embodiment of the invention.

FIG. 3 depicts a block diagram of a controller for use in a storage subsystem according to an exemplary embodiment of the invention.

FIG. 4 shows a block diagram of a user interface for controlling and communicating with the storage subsystem according to an exemplary embodiment of the invention.

### DETAILED DESCRIPTION

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

FIG. 1 shows an information handling system 100 that includes a storage subsystem according to an exemplary embodiment of the invention. Generally speaking, system 100 may constitute a host or server computer system, workstation, and the like, as desired. System 100 includes one or more processors 106, one or more buses or communication media 103, video/graphics hardware 109, storage subsystem 118, memory 121, input/output (I/O) 112, peripherals 115, and communications apparatus 125.

Bus 103 provides a mechanism for the various components of system 100 to communication and couple with one another and thus acts as the backbone of the system. Processor 106, video/graphics 109, storage subsystem 118, memory 121, I/O 112, communications apparatus 125, and peripherals 115 have the structure, and perform the functions, familiar to persons of ordinary skill in the art who have the benefit of the description of the invention.

Note that FIG. 1 provides merely an illustrative and simplified block diagram or architecture of system 100. One may readily use alternative architectures or structures, and yet take advantage of the inventive concepts, by making modifications that fall within the knowledge of persons of ordinary skill in the art who have the benefit of the description of the invention.

The inventive concepts contemplate information handling systems with storage subsystems or devices that include write filters. The write filters help to protect against malware, as described below in more detail. One may use the novel storage subsystems with a variety of hardware and software, such as Microsoft Windows, Linux, UNIX, Macintosh operating system, and the like, as persons of ordinary skill in the art who have the benefit of the description of the invention understand.

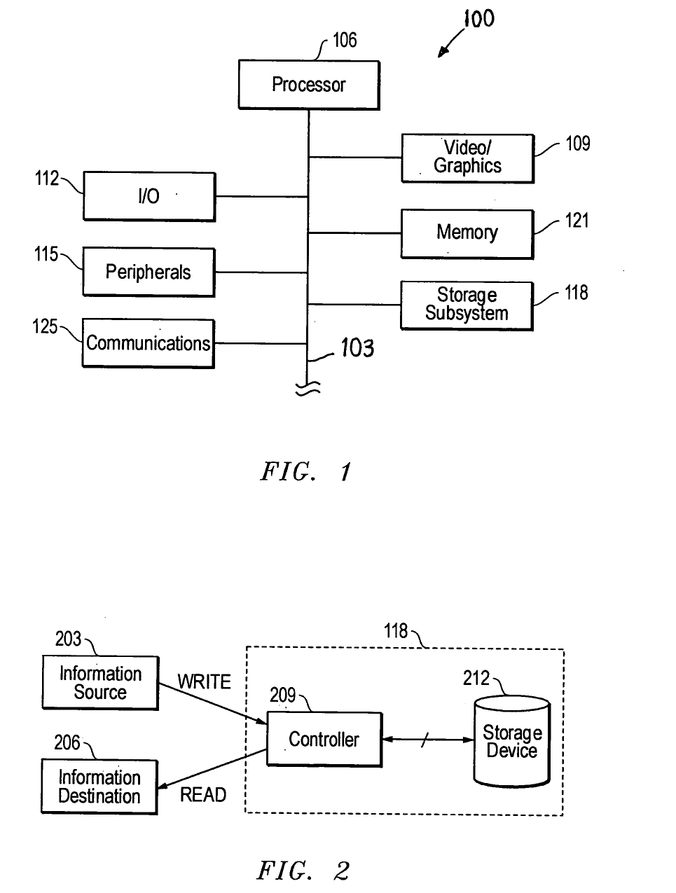

FIG. 2 shows more details of storage subsystem 118 according to an exemplary embodiment of the invention. In the embodiment shown, storage subsystem 118 includes controller 209 and storage device 212.

Storage device 212 may constitute a wide variety of apparatus for storing and retrieving information, as persons of ordinary skill in the art who have the benefit of the description of the invention understand. By way of example, storage device 212 may constitute one or more (or a part of, or a combination of) hard drives; redundant array of independent disks (RAID); magnetic tape drives; non-volatile memories, such as flash memory; floppy or diskette drives; optical drives, such as DVD or CD; magneto-optical drives; network drives; virtual drives (software emulated drive), etc.

Controller 209 facilitates accepting of information for writing to storage device 212 in connection with a write operation. Furthermore, controller 209 provide information from storage device 212 in connection with a read operation.

More specifically, in connection with a write operation, controller 209 accepts write information or data from information source device 203 for ultimate storage in storage device 212. Information source device 203 may constitute any device that provides information as its output, as desired, and as persons of ordinary skill in the art who have the benefit of the description of the invention understand. Examples include memory, processor, I/O devices, peripherals, communications devices, etc.

Furthermore, in connection with a read operation, controller 209 obtains information from storage device 212 and provides the information to information destination device 206. Information destination device 206 may constitute any device that accepts information as its input, as desired, and as persons of ordinary skill in the art who have the benefit of the description of the invention understand. By way of example, information destination device may constitute memory, processor, video/graphics devices, peripherals, I/O devices, communication devices, etc.

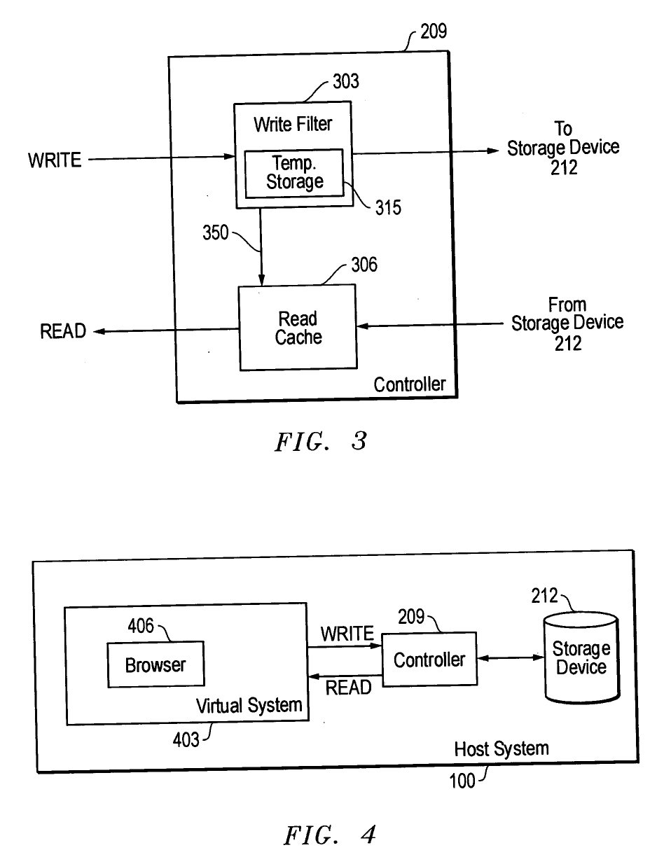

FIG. 3 shows a simplified block diagram that provides more details of controller 209 in an exemplary embodiment according to the invention. Controller 209 includes write filter 303. Write filter 303 provides protection against malware, as described below in detail.

Write filer 303 acts as a filter driver for the file system. It intercepts write operations to the file system (on storage device 212). When the operating system, an application or, generally, any part of system 100 tries to perform a write operation to storage device 212, write filter 303 writes the information to a temporary storage device 315. Thus, by not writing the information directly to storage device 212 at that point in time, controller 209 helps to avoid infecting the system with viruses, adware, spyware and, generally, malware.

At various points, controller 209 (or another part of system 100, generally) may selectively write to storage device 212 some or all of the information stored in temporary storage device 315. Controller 209 may do so by posing a query to the user and obtaining a response from the user, through automatic selection criteria, such as the results of a scan for malware or the size of the data in temporary storage device 315 exceeding a threshold, after expiration of a desired amount of time, or any combination of those techniques, as desired.

For example, in one embodiment, controller 209 may query the user, and obtain a response from the user. Controller 209 may further cause the writing to storage device 212 of some or all of the information in temporary storage device 315, or discard some or all of the data, according to the user's response.

In another embodiment, controller 209 may cause the running of appropriate software to scan system 100 (such as memory 121, storage device 212, etc.) for malware. Controller 209 may then present the results of the scan to the user, and query the user for action. Depending on the user's response, controller 209 may cause the writing to storage device 212 of some or all of the information in temporary storage device 315, or discard some or all of the data. Note that controller 209 may perform a scan at the conclusion of the user's activities (or termination of one or more processes), or during regular or irregular intervals (such as the occurrence of an event, for example suspicious activity in system 100), as desired.

In a third embodiment, controller 209 allows the user to scan for malware when the user deems appropriate. After the user has caused performance of a scan for malware, controller 209 may pose a query to the user for action. The user will then respond, depending on the results of the scan. Controller 209 may cause the writing to storage device 212 of some or all of the information in temporary storage device 315, or discard some or all of the data, according to the user's response.

In yet another embodiment, the user may provide criteria for saving or discarding of the data in temporary storage device 315. Controller 209 may use the pre-determined criteria, with or without the results of a scan for malware, to save or discard some or all of the data in temporary storage device 315.

Many possibilities exist for specifying the behavior of controller 209. For example, the user may specify that, if the scan shows the presence of malware, controller 209 should discard the data in temporary storage device 315. As another example, the user may direct that, if the scan shows no known malware present in the data in the temporary storage device 315, controller 209 should save some or all of the data to storage device 212.

As yet another example, the user may specify the timing of performing scan(s) on system 100 (e.g., at the conclusion of the user's activities, upon termination of one or more processes, at regular or irregular intervals, upon the occurrence of one or more events, and the like). In general, the user may gauge the desired action to the results of the scan, for example, to the presence, severity, number, and/or type of malware, as desired.

As persons of ordinary skill in the art who have the benefit of the description of the invention understand, one may use many other schemes to avoid infecting system 100 by using controller 209 (including write filter 303 and temporary storage device 315). Thus, the above description merely provides examples of possible schemes and does not limit the range or scope of possible schemes for protecting system 100.

Typically, temporary storage device 315 holds less data than does storage device 212. As a result, scanning the data in storage device 315 rather than the data in storage device 212 takes less time (all other things being equal). Consequently, the inventive concepts provide an efficient mechanism for detecting and avoiding malware, compared to scanning after the malware has potentially infected system 100.

In various embodiments, temporary storage 315 device may constitute a wide variety of devices, as desired, and as persons of ordinary skill in the art who have the benefit of the description of the invention understand. By way of example, temporary storage device 315 may constitute one (or more, or a part of, or a combination of) hard drive, memory (e.g., flash memory), optical drive, etc.

Furthermore, controller 209 may optionally include read cache 306. Read cache 306 performs the functions of cache circuitry, as persons of ordinary skill in the art who have the benefit of the description of the invention understand. Briefly, by using a desired caching algorithm or technique, read cache 306 caches information received from storage device 212. As a result, controller 209 need not repetitively access storage device 212 to obtain information from it. Because storage device 212 ordinarily has a longer access time than does read cache 306, the addition of read cache 306 tends to decrease the read latency of controller 209.

Note that temporary storage device 315 holds modified information (not written yet in storage device 212). When any part of the system seeks to read the modified information from storage device 212, controller 209 fetches the information instead from temporary storage device 615 (through coupling or path 350) and present it to information destination 206.

One may apply the inventive concepts to virtual computing environments, as desired. In a virtual computing environment, a host operating system runs on a host computer system. A guest operating system may run on the host operating system. As a result, the host operating system, with appropriate virtual computing application software, provides a virtual computing environment.

FIG. 4 shows a block diagram of a virtual computing environment according to an exemplary embodiment of the invention. More specifically, host system 100 provides a mechanism for running virtual system 403. Virtual system 403 communicates with storage device 212 through controller 209. By using controller 209 (including write filter 303 and temporary storage device 315), one may protect system 100 (the host computer system) against malware. More specifically, one may use the techniques described here to detect malware and prevent infecting various parts of system 100.

Virtual system 403 may include a mechanism for communicating with the user to pose queries to the user and to obtain responses from the user. Generally, one may use a wide variety of communication protocols, processes, programs, and apparatus for the transmission, routing, and reception of the communication with the user, as desired. By way of an example, in the illustrative embodiment shown, browser 406 provides a way of communicating with the user.

As noted, one may user a variety of protocols, such as the Hyper Text Transfer Protocol, or HTTP (the protocol used by the World Wide Web protocol) to communicate with the user. Typical computer systems include browsers with built-in HTTP capability. Controller 209 may exploit this capability and use the browser's HTTP protocol to communicate with the user.

As another example, one may use the Hyper Text Transfer Protocol Secure sockets, or HTTPS, to communicate with the user. The browser included with a typical computer systems has built-in HTTPS capability. Controller 209 may exploit this capability and use the browser's HTTP protocol to communicate with the user.

Note that the HTTPS protocol allows secure communication between the user and controller 209 (or other parts of the virtual or host system, as desired). The secure communication can facilitate tasks such as authentication of the user, and communication of sensitive information to and from the user.

Referring to the figures, persons of ordinary skill in the art will note that the various blocks shown may depict mainly the conceptual functions and signal flow. The actual circuit implementation may or may not contain separately identifiable hardware for the various functional blocks and may or may not use the particular circuitry shown. For example, one may combine the functionality of various blocks into one circuit block, as desired. Furthermore, one may realize the functionality of a single block in several circuit blocks, as desired. The choice of circuit implementation depends on various factors, such as particular design and performance specifications for a given implementation, as persons of ordinary skill in the art who have the benefit of the description of the invention understand. Other modifications and alternative embodiments of the invention in addition to those described here will be apparent to persons of ordinary skill in the art who have the benefit of the description of the invention. Accordingly, this description teaches those skilled in the art the manner of carrying out the invention and are to be construed as illustrative only.

The forms of the invention shown and described should be taken as the presently preferred or illustrative embodiments. Persons skilled in the art may make various changes in the shape, size and arrangement of parts without departing from the scope of the invention described in this document. For example, persons skilled in the art may substitute equivalent elements for the elements illustrated and described here. Moreover, persons skilled in the art who have the benefit of this description of the invention may use certain features of the invention independently of the use of other features, without departing from the scope of the invention.

1. An information handling system, comprising a write filter coupled to a storage device, the write filter configured to selectively provide information to the storage device, depending, at least in part, on whether malware is detected in the information.

2. The information handling system according to claim 1, further comprising a host computer system.

3. The information handling system according to claim 2, further comprising a virtual computing environment.

4. The information handling system according to claim 3, further comprising a browser that allows communication with a user, wherein the user uses the browser to scan the information in order to decide whether the information should be provided to the storage device.

5. The information handling system according to claim 1, wherein the information is scanned to detect whether any malware is present.

6. The information handling system according to claim 5, further comprising a temporary storage device configured to hold the information before the information is scanned.

7. The information handling system according to claim 1, wherein a result of scanning the information is presented to the user, and wherein the user decides whether the information should be provided to the storage device.

8. An apparatus, comprising:
a controller, comprising:
a write filter; and
a temporary storage device coupled to the write filter,
wherein the write filter stores information in the temporary storage device to determine presence of malware in the information.

9. The apparatus according to claim 8, further comprising a storage device coupled to the controller.

10. The apparatus according to claim 9, wherein the controller provides to the storage device the information stored in the temporary storage device depending on whether malware is present in the information.

11. The apparatus according to claim 10, wherein the information is scanned in order to determine presence of malware in the information.

12. The apparatus according to claim 10, wherein a user decides whether the information in the temporary storage device should be provided to the storage device.

13. The apparatus according to claim 12, wherein the user's decision is based at least in part on scanning the information to determine presence of malware.

14. The apparatus according to claim 11, wherein the information is scanned at the conclusion of a process, at regular intervals, at irregular intervals, or when the information exceeds a size threshold.

15. A method of preventing infection of a computer system with malware, the method comprising:
temporarily storing information in the computer system;
scanning the information to determine presence of malware; and
using a write filter to cause saving of the information in the computer system, depending on whether scanning the information detects presence of malware.

16. The method according to claim 15, wherein using a write filter to cause saving of the information in the computer system further comprises:
communicating with a user by:
presenting to the user a result of scanning the information;
posing a query to the user for action;
receiving a response from the user; and
selectively saving the information to a storage device in the computer system based on the response from the user.

17. The method according to claim 16, wherein scanning the information further comprises scanning the information at regular intervals, at irregular intervals, upon an occurrence of an event, at termination of an event, or when the temporarily stored data exceeds a size threshold.

18. The method according to claim 15, wherein the computer system comprises a virtual computing environment.

19. The method according to claim 18, wherein temporarily storing information in the computer system further comprises storing information provided by the virtual computing environment.

20. The method according to claim 16, wherein communicating with the user further comprises using a browser.
